(19) United States
(12) Patent Application Publication
(10) Pub. No.: US 2023/0070402 A1
(43) Pub. Date: Mar. 9, 2023

(54) COMPUTERIZED SYSTEM AND METHOD FOR IMPROVING EFFICIENCY OF SALE AND PURCHASE OF NAME, IMAGE, AND LIKENESS (NIL) LICENSES

(71) Applicant: James E. Beecham, West Palm Beach, FL (US)

(72) Inventor: James E. Beecham, West Palm Beach, FL (US)

(21) Appl. No.: 17/844,221

(22) Filed: Jun. 20, 2022

Related U.S. Application Data
(63) Continuation-in-part of application No. 17/470,193, filed on Sep. 9, 2021, now abandoned.
Application No. 17/470,193 is a continuation-in-part of application No. 17/582,875, filed on Jan. 24, 2022, now abandoned.
Application No. 17/582,875 is a continuation-in-part of application No. 17/825,917, filed on May 26, 2022.

(51) Int. Cl. G06Q 30/06

(52) U.S. Cl. CPC G06Q 30/0601

(57) ABSTRACT

A system and method for improving efficiency of sale and purchase of NIL (Name, Image, and Likeness) licenses. In a preferred embodiment, instant invention comprises simultaneous license-group purchase with single click to execute. In a preferred embodiment, instant invention comprises synchronized plurality of databases supporting preserving amateur status of student-athletes despite these athletes' participation in sale and purchase of NIL licenses. Instant invention typically comprises plurality of registered users of online licensing platform each agreeing to same electronically displayed license agreement terms. Instant invention typically comprises group purchase of licenses comprising simultaneous purchase of NIL license from each of a plurality of student-athletes of same sports team.

### CROSS-REFERENCE TO RELATED APPLICATIONS

The present application is a continuation in part application to U.S. Non-Provisional application Ser. No. 17/470,193 filed 9 Sep. 2021 entitled ‘METHOD AND SYSTEM FOR SPORTS ATHLETE SELLING USE-OF-NAME LICENSE TO FAN TO ENABLE DISPLAY OF SAID ATHLETE NAME IN AD ENDORSEMENT OF TEAM SPIRITEDNESS OF SAID FAN ON SAID FAN SOCIAL MEDIA PAGE’, and to non-provisional application Ser. No. 17/582,875 filed 24 Jan. 2022 entitled ‘ONLINE LICENSING PLATFORM WITH ADDITIONAL FEATURES’, and to non-provisional application Ser. No. 17/825,917 filed 26 May 2022 entitled ONLINE LICENSING PLATFORM COMPRISING PRE-AUTHORIZATION BLOCK, RATINGS OF ATHLETES' PLATFORM-RELATED ACTIVITIES, LINK TO VIEW AMATEUR ATHLETE ONLINE SOCIAL MEDIA POSTS, AND LIVE STREAMING, the disclosures of which are hereby incorporated in their entirety at least by reference.

### BACKGROUND OF THE INVENTION

### 1. Field of the Invention

The present invention generally relates to sale and purchase of name, image, and/or likeness (NIL) licenses. More specifically, present invention relates to use of online licensing platform to allow efficient license-group purchases of NIL licenses.

### 2. Description of Related Art

Prior art includes 20160196590 A1 by Morgan, 20130246633 A1 by Giesen, and 20190220882 A1 by Fojtik.

### BRIEF SUMMARY OF THE INVENTION

In one embodiment of the present invention, an online licensing platform comprises a selection by therein registered user to select ‘Build a team roster’. By said selection, a user with knowledge of names of athletes chosen by school/coach at a school, to participate on a school team, said knowledgeable user is allowed, within instant invention online licensing platform, to compile a Team Roster (TR), i.e., a list of athletes on a said team.

In a preferred embodiment, said TR can record the student-athlete identifications and related data as may represent those athletes. In a preferred embodiment, such TR compiled within online licensing platform and stored in database, comprises registration numbers corresponding to said student-athletes, and the respective players' names, as well as photo and designation of playing position or category.

In a preferred embodiment, said TR-compiling user is further allowed, by means supplied in platform, to ‘lock’ said TR list, such lock comprising designating said compiling fan-user as the sole person allowed to edit said list within said platform. In a preferred embodiment, said list of student-athletes comprising team roster can comprise, for example, identification of high school team athletes chosen to play soccer for the high school.

In a preferred embodiment, said team roster can comprise identification of college team players selected by school/coach to play on the college's team for basketball. In a preferred embodiment, the TR can comprise annotations applied by said compiling user. Such annotations can comprise designation of TR as representing Varsity team, or Junior Varsity Team, or Red Shirt team, or Injured Reserve list, or Practice Squad. In a preferred embodiment, said annotations can comprise designation of which player has been selected to be a starting position player, i.e., to be among those players who begin the game on the field or court, assigned by coach to be ready to play for the school team at the start of the game, a Starter.

In a preferred embodiment, multiple users can compile and register within platform-linked database, each their own team roster. Thus, a plurality of TRs for same school team can be stored in database of online licensing platform. In a preferred embodiment, the database of platform can comprise, for example, two soccer team rosters, each compiled by a different platform-registered fan, each TR comprising a list of student-athlete names and photos and player positions for student-athletes who compiling-users each represent as selected by school/coach of school to play for said school on said team.

In a preferred embodiment, said list or team roster is viewable by buyer-fan users registered to the site/platform. The viewing user can select to see the TR of athletes by searching for and/or seeing displayed at least one list-related item of list: the school's name, the sport linked to said list, the designation of varsity or junior varsity if applied, the name of the list-maker, the date of the last update to the list, the playing positions of the listed players corresponding to the TR-listed registration numbers.

In a preferred embodiment, the TR lists compiled into database by users are searchable by other users registered in the online licensing platform. In a preferred embodiment, the search criteria comprise selection for search of high school TR or college team roster, the name of the school, the state where school is located as the city of location if college or the county of location if high school, the sport, and the gender of the team. In a preferred embodiment, the search can be initiated by user by only entering the T-number or Team list number of the roster.

In a preferred embodiment, if more than one list is linked to results of input of search criteria, software programming allows searching user to view the multiple TR list numbers. The user is allowed to select one of the T #'s corresponding to list user wishes to see. One factor in choosing can be the displayed name of the maker of the list, or the date last updated for the list, or the number of registered athletes on list as indicated. Based on the selection of a list T number, the display of corresponding selected list is viewable by searching user.

In a preferred embodiment, user viewing a TR list is thus allowed to see the designations and annotations, such as the playing position designations for athletes on team list. For example, in the TR list representing a football team roster, the letter Q can represent quarterback, and the letter L can represent linebacker, and the letters OL can represent offensive lineman, and so forth.

In a preferred embodiment, searching user can purchase a name-license from a player of TR list. In a preferred embodiment, searching user can select a plurality of players from the team list, and by click or a series of clicks can configure and approve a simultaneous purchase of a name-license from each of said plurality of players.

In a preferred embodiment, searching user can view a registered player's profile, said profile typically providing user with view of photograph of athlete, and a view of video of athlete with audible speaking by athlete. In a preferred embodiment, when viewing the profile confirms the identity of the athlete to user's satisfaction, and whereby user wishes to complete a purchase of NIL license from said player, the profile links to means for accomplishing said license purchase.

In a preferred embodiment, user choosing the license-group purchase option is allowed to check mark a plurality of the players on the team list. In a preferred embodiment, user can further designate a price selection to be applied as same price to each of group of players selected by user for license-group purchase.

In a preferred embodiment, user can view a calculated total of said license-group purchase at price designated by user. In a preferred embodiment, where user approves the license-group purchase he has thus configured, user can click a single button to execute said simultaneous purchase of selected licenses at selected same price each license. In a preferred embodiment, user does so by clicking an ‘Approve purchase’ button which activates the purchase and subtracts the total amount due from payment method of buying user.

The system and method herein disclosed is more efficient as compared to other methods of license purchase of prior art. Such increased efficiency comprises instant invention system and method which uses less time and takes less effort for buying user. Such improved efficiency is at least by comparison, for example, to user buying multiple NIL licenses one by one with meetings and contract signings for each purchase. Furthermore, the instant invention method and system is more efficient than the standard agent/lawyer-involved one-by-one negotiation and purchase as in prior art. For example, efficiency occurs by virtue of the instant invention pre-approved license terms, as agreed to by each of system-registered buyer and system-registered seller.

In a preferred embodiment, a further level of flexibility and efficiency is disclosed as achievable within the instant invention even as compared to previously disclosed automated or computerized methods and systems. For example, such flexibility and efficiency are allowed within instant invention where user selects a group A of licenses for simultaneous purchase, and wherein user can immediately make a selection of price for said group A, and immediately view the calculated total for group A licenses purchase, and then immediately click to approve the license-group A simultaneous purchase of NIL licenses under pre-agreed license terms.

In a preferred embodiment, as even more efficiency and flexibility of instant invention, user can subsequently and immediately after the Group A purchase, same user can then immediately designate a group B of licenses for simultaneous purchase at a different price. In a preferred embodiment, the user then immediately can view the calculated total for purchase of said group B, then if user agrees to the said total, user can then immediately click the ‘Approve Purchase’ to consummate the purchase of the said group B licenses, again under pre-agreed license terms.

In a preferred embodiment, the decisions by user for group A purchase and group B purchase can be spontaneous and with no other input needed than user's actions as disclosed above. Such actions of user can be correlated during selection by user, such as to the annotations on team list, as applied by list-maker user. For example, buying-user could comprise the group A to include licenses for sale by offensive linemen of the team by noting the position designations on each player information provided. The buying user could comprise the group B as licenses for sale by defensive linemen of the same team. Such configuring of license-group purchases and execution thereof can take only seconds.

In a preferred embodiment, comparative efficiency of instant invention comprises using relatively less cumulative time and effort in license sale and purchase, such as less negotiation time, such as less effort by or on behalf of buyer, and less time and effort by or on behalf of seller. By comparison, standard NIL purchase and sale activities today typically involve extensive agent representation for those few student-athletes at the highest level of athlete performance and potential. Furthermore, standard NIL deals today, even if assisted by computerization, typically involve line by line review of differing contracts by lawyers. Such one-of-a-kind deals can comprise a complicated scheme of potential reimbursements, such as depending on achievement of certain targets by the athlete.

In a preferred embodiment, instant invention's comparative efficiency allows many student-athletes, including those of more modest athletic prowess, to participate in NIL license sales with minimal time spent by said athletes or their representatives. In a preferred embodiment, said many student-athletes or more modest athletic prowess can concurrently sell NIL licenses to fan-buyers located across a continent, all with no effort at the specific time of sale by any of these many student-athletes.

In a preferred embodiment, the registration process for each of the student-athletes and buyers registering into computerized system of instant invention, said registration process comprises the athlete and buyer to each agree to a written set of terms for the sale and purchase of NIL license within online licensing platform. In a preferred embodiment, the price is selected by buyer at time of purchase, said selection typically from a pre-determined range, said range linked to the terms pre-agreed at registration by both parties.

In a preferred embodiment, the range is from four dollars per name-use license purchase to one thousand dollars per name-use license purchase. Typically said name-use license is mutually agreed between buyer fan and seller athlete to provide buyer a right to display a badge of team-spirit-endorsement with athlete's name affixed. In a preferred embodiment, said buyer-fan is authorized to display said badge on buyer's social media for a period of ten days for each dollar of price paid for said name-use license. Typically, the badge which bears the licensed athlete's name is downloaded from online licensing platform computer and amenable for display on social media as digital badge to be seen by visitors to said social media page, such as Facebook or the like.

In terms of efficiency as herein defined and evaluated, the standard and prior art means for purchase and sale of NIL license is inefficient in time and effort required, as compared to the increased efficiency of instant invention method and system. Protracted negotiations of NIL deals using standard means can typically involve lawyer, agent, and tax advisor. Furthermore, the typical prior art NIL deal, even if arranged in part by computer, tends to differ one deal to the next, requiring different sets of terms and expenditure of further time and effort to draft and obtain review and agreement on such differences. Such inefficiency might be justifiable for large dollar amount deals, where the cost of agent, lawyers and the like are ‘absorbed’ into the overall deal's considerable value. However, for the smaller dollar amount NIL deals, which are easily managed by instant invention method and system herein disclosed, such small amount deals in prior art are, by contrast, usually not possible because of structure of costs, and extensive expenditure of time and effort. The result from prior art means is that fewer or no such smaller dollar value deals are done. For example, a deal for four dollars purchase price of NIL license is unlikely to even be considered with prior art means. Such small dollar NIL license sales and purchases are easily and efficiently supported within instant invention method and system.

In a preferred embodiment, instant invention comprises a computer-enabled system for improving efficiency of sale and purchase of NIL licenses, said system comprising simultaneous license-group purchase. The system further comprises, in a preferred embodiment, a single click to execute said license-group purchase. The system further comprises, in a preferred embodiment, a synchronized plurality of databases wherein data from a first database is compiled to a second database as team list component.

In a preferred embodiment, instant invention comprises same price per plurality of licenses within said license-group purchase, said group purchase of licenses comprising purchase of license from each of a plurality of athletes of same sports team. In a preferred embodiment, instant invention comprises group purchase of licenses as comprised of licenses from athletes each of at least similar playing designation.

In a preferred embodiment, instant invention comprises a method for electronically allowing group purchase of NIL licenses, said method comprising steps of using online licensing platform, and allowing said purchase as simultaneous. In a preferred embodiment, instant invention further comprises step of plurality of registered users of said platform each agreeing to same electronically displayed license agreement terms.

In a preferred embodiment, instant invention comprises a computerized system for improving efficiency of sale of NIL licenses, said system comprising means for a user to agree to license terms electronically, and means for said user to purchase at least one license from each of a plurality of student-athletes registered on system. In a preferred embodiment, instant invention further comprises allowing said user to pay same price to each of said plurality.

In a preferred embodiment, instant invention further comprises at least one of: downloadable badges, restriction of edit permission regarding team list, a plurality of synchronized searchable databases, each comprising data regarding online license platform-registered student-athletes. In a preferred embodiment, instant invention further comprises at least one of: list of states comprising those states having legal approval of NIL for high school student-athletes, user-selected designation regarding at least one of varsity, junior varsity, offense, defense, lineman, quarterback, safety, receiver, point guard, shooting guard, center, forward.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a schematic of a preferred embodiment.

FIG. 2 is a schematic of a preferred embodiment.

FIG. 3 is a schematic of a preferred embodiment.

FIG. 4 is a table of a preferred embodiment.

FIG. 5 is a schematic of a preferred embodiment.

FIG. 6 is an illustration of a preferred embodiment.

FIG. 7 is an illustration of a preferred embodiment.

FIG. 8 is an illustration of a preferred embodiment.

FIG. 9 is a chart of a preferred embodiment.

FIG. 10 is a chart of a preferred embodiment.

FIG. 11 is a schematic of a preferred embodiment.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a system and method for improved efficiency in sale and purchase of NIL licenses, such as in a license-group configuration.

The word “a” is defined to mean “at least one.” The word ‘efficiency’ is defined as ability to accomplish a job with relatively less expenditure of time and effort.

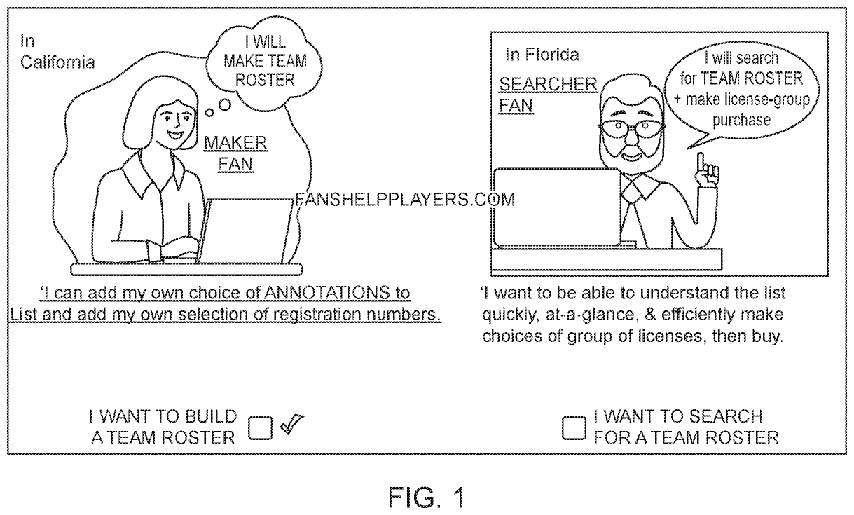

FIG. 1 is a schematic depicting a ‘maker fan’, the woman on the left, and a ‘Searcher Fan’, the man on the right. The maker fan is a registered user of the instant invention online licensing platform. She is depicted as residing in California and interested to compile a team roster. In a preferred embodiment, the team roster she compiles comprises registration numbers she finds in a search of a database called herein DB1. The DB1 database comprises names of athletes registered in online licensing platform, said registration providing each athlete a unique registration number. In a preferred embodiment, she is a parent of one athlete of a school team. By such pre-existing knowledge of the school team players, she is capable to use instant method and system to compile an accurate team roster. For example, she knows the physical appearance of the athletes of the team and can verify their photos. She knows the name of the school and the location of the school. She knows details of player position and of course the sport they play and their gender. With such information, she can compile a team roster within a database of the instant invention, said team roster stored in database herein called DB2.

In a preferred embodiment, DB1 and DB2 are synched, i.e., the data easily transported from DB1 to DB2 to comprise the team list, such as by single click of button to post data of photo of player, player's name from DB1 to the team roster in DB2. The system comprises means for her to search for athletes and compare the profile photo and video to her knowledge of the athletes of the team. When she finds a registered athlete whom she knows is on the team, and whose profile details confirm the fact, she can enter the registration number, as detailed in subsequent figure below. In this manner, she gathers data for the roster. Data synchronization provides a means of creating harmony and consistency among all the systems that have access to data.

The figure sketched on the right of FIG. 1, the man, he can search for team rosters listed in the database 2, or DB2. This is the same database where the Maker-fan will store data of the team roster she is compiling. The words attributed to a typical searcher-buyer-fan are listed below the sketch of the man: “I want to be able to understand the list quickly, at-a-glance, and efficiently make choices of group of licenses, then buy′.

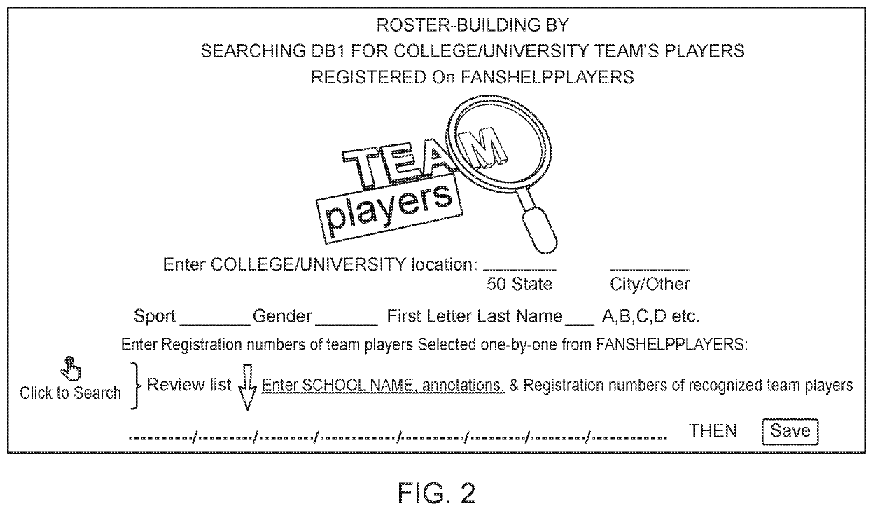

FIG. 2 is a schematic depicting data entry screen used by Maker-fan for searching and transferring data regarding the team roster she is compiling. DB1, a searchable database of student-athletes registered on the online licensing platform, comprises the source of the athlete photos, names, and registration numbers which maker fan will transfer from DB1 to DB2 Team Roster. She will also add the name of the school, sport, gender of team athletes, and annotations. The first letter of last name of athlete is one of the search criteria in DB1 which she uses to find the registration in DB1 of the student-athletes. The team roster example in FIG. 2 is for a college team, requiring a city location in the system in a preferred embodiment.

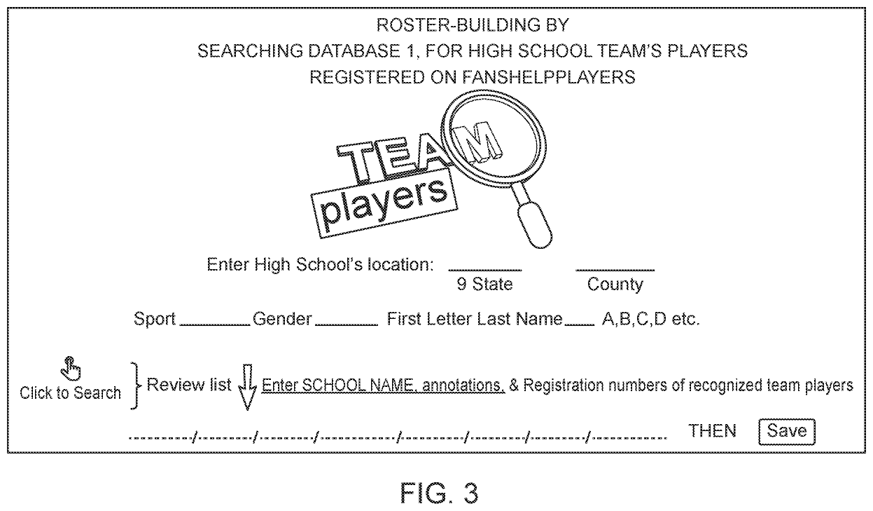

FIG. 3 is a schematic depicting data entry screen used by a Maker-fan compiling a team roster of a college team, requiring a city location in a preferred embodiment of the system. As in FIG. 2, data for the team roster is compiled by searching DB1, the searchable database of student-athletes registered on the online licensing platform. The annotations here will differ from those of FIG. 1, depending on the sport of the college team for example.

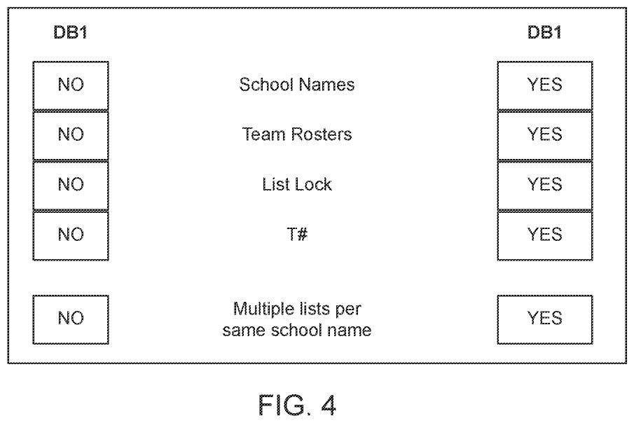

FIG. 4 is a table illustrating a comparison of DB1 and DB2. As indicated, the DB1 does not have school names, team rosters, means for a lock of edit for list, a T or Team number for lists, or multiple lists per same school name—while DB2 typically comprises all the highlighted data.

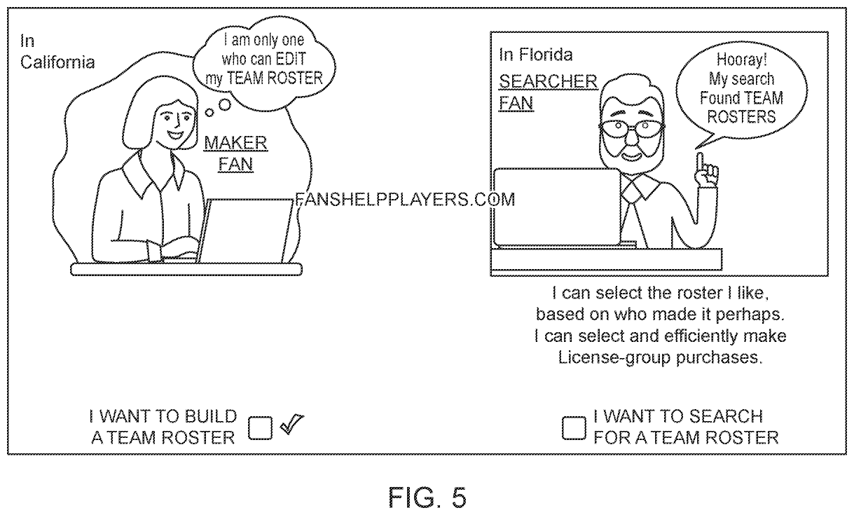

FIG. 5 is a schematic depicting the man on right expressing Searcher fan goal of selecting by search of DB2, the team roster he finds and prefers. His choice optionally is at least partly based on whose name is listed on the roster as maker-fan. If, for example, the name is same name as the coach of team, and the man recognizes said coach's name on the roster, that name of coach can be a factor in maker-fan's choice of that specific list. The expressed wish of typical searcher-buyer fan is to efficiently make his license purchases, such as to save time for the buyer. Furthermore, buyer wishes to have choice even of small dollar amount license buys. In efficiently allowing such, the instant invention promotes funding for student-athletes of modest athleticism, a group in need often of such funding as compared to more famous and talented athletes.

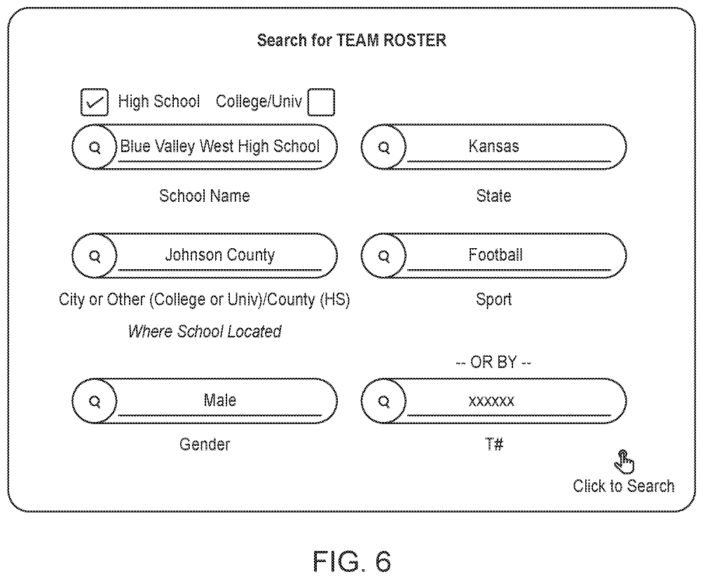

FIG. 6 illustrates the DB2 search criteria-entry fields wherein search criteria are entered by searcher-buyer-user. At top left, the searcher fan first indicates by click if he is seeking a high school team roster or a college team roster. The searcher then enters data into the five data fields relative to his choice: school name, state, location within state, sport, and gender of athletes. Alternatively, if searcher knows the T # he can enter it instead of the other data. Then he clicks to start electronic search.

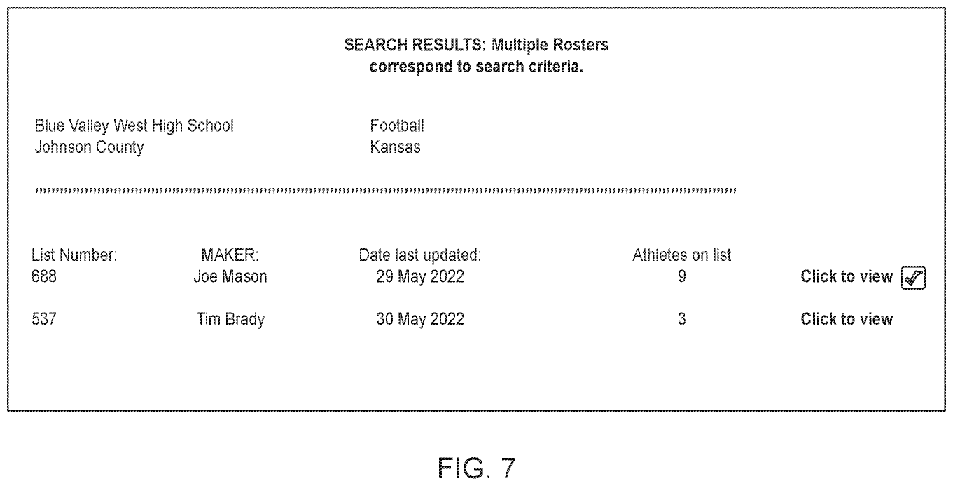

FIG. 7 illustrates the results of search from FIG. 6. The data indicates there are two team rosters matching the criteria entered in the search fields, i.e., a T #688 and a T #537. Searcher fan selects the T #688.

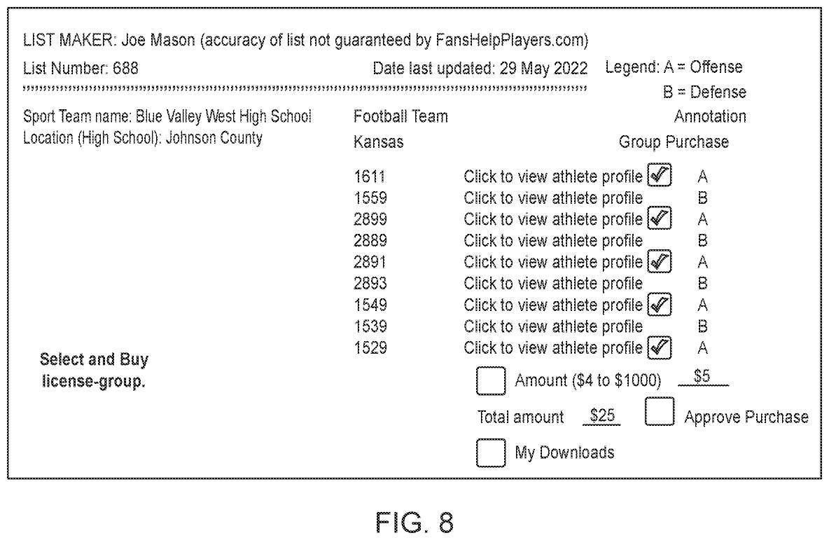

FIG. 8 illustrates the T #688 team roster with annotations and name of maker-fan, i.e., Joe Mason. Where Joe Mason is legitimately the name of coach of the specific team which searcher-buyer-fan seeks to support, then Joe Mason's team roster can expect to receive use by such a knowledgeable fan-buyer. In a preferred embodiment, the means for license-group purchase are in effect. In accordance with his desire to use said license-group purchase, that option is selected by buyer fan. In this circumstance, buyer can view the annotation and legend which indicate five of the roster numbers represent athletes of the specified team who play on the offense in the football team's games. In the circumstance where the buyer-fan wishes to purchase a group of licenses, one license each from each of the listed offense-side athletes, buyer clicks next to each of the five lines corresponding to the annotation A, which the legend indicates correspond to offense-side players. The buyer then uses the means for selecting a price. The buyer selects a price of five dollars, which will be applied as five dollars paid to each of the five check-marked athletes. The computer programming executes a computation and displays to the buyer fan a total for said license-group purchase, i.e., twenty-five dollars total. Buyer fan has opportunity to review the amount displayed. If buyer fan wishes to make the simultaneous license-group purchase, i.e., purchase of one license each paying to each of the five check-marked athletes, at a price each license of five dollars, then buyer-fan clicks ‘Approve Purchase’.

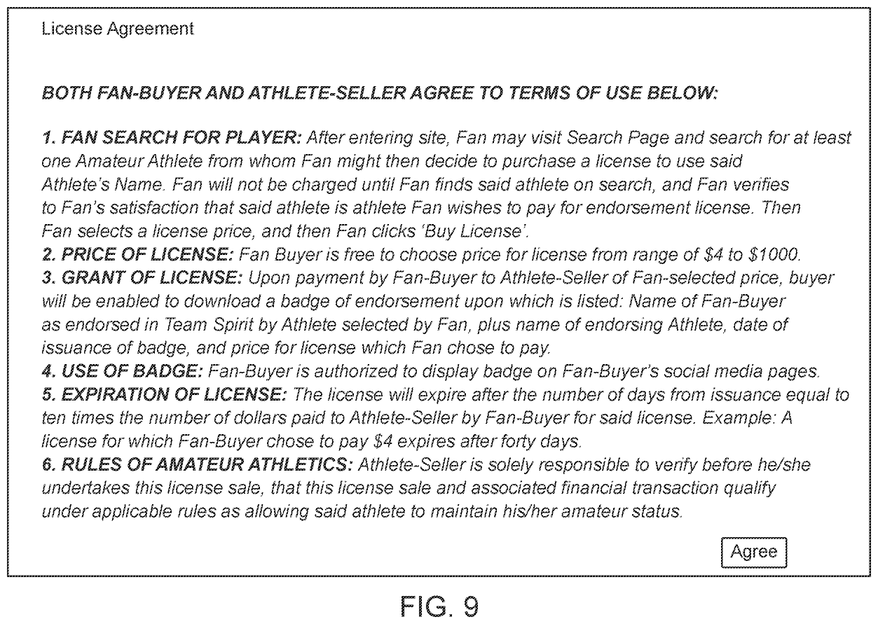

FIG. 9 is a chart such as used in a preferred embodiment of instant invention. Online licensing platform displays chart to registering users, requiring that the user, to complete registration, must agree to terms explained in license agreement on chart. The agreement to identical terms by each registered student-athlete license-seller, and each prospective fan-buyer, this agree/agree circumstance comprises means for improved efficiency of sale and purchase of NIL licenses within method and system of instant invention.

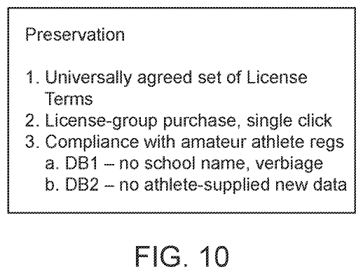

FIG. 10 is a chart listing advantages of instant invention method and system, such advantages as for example accrue to preservation of amateur status for student-athletes using instant invention. The student-athlete could theoretically be in danger of losing amateur status if student-athlete is found by officials to be receiving pay for athletic performance. The rules and laws governing student-athlete amateur status across the fifty states, in both high school and college sports, these rules typically state or imply that an athlete who receives pay for athletic performance can lose amateur status. Instant invention comprises several benefits which collectively combine to preserve amateur status for student-athletes at least considering registration on system. Among these are instructing athletes to avoid using school name or verbiage if school has indicated such use is prohibited within student-athletes NIL activities. In a preferred embodiment, for example, school name used in instant invention is supplied by a fan. Further benefit tending to avoid loss of amateur status are agreed set of license terms in writing, as required by some schools in some jurisdictions. Further benefit tending to avoid loss of amateur status are license-group purchase which can occur on team list compiled by coach, an official knowledgeable and careful to maintain amateur status for his players. Thus, if coach believed his athletes could not participate in team listing without risking their amateur status, coach would not place their names on list.

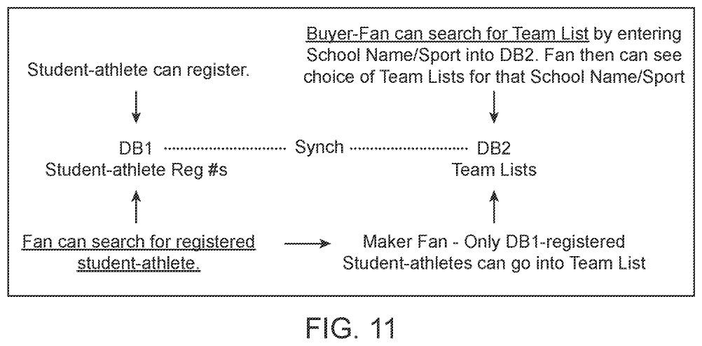

FIG. 11 is a schematic which outlines arrangement of databases in a preferred embodiment. The DB1 and DB2 databases are synchronized such that data is easily duplicated on DB2 from DB1. The separation of DB2 from DB1 also bolsters the preservation of amateur status, as for example by keeping the school's name data separate from the database DB1 which houses the direct registration by student-athletes. The statement ‘Only DB1-registered Student-athletes can go into Team list’ refers to data, i.e., only the DB1-registered Student-athletes can comprise the TR listed athletes in DB2. In a preferred embodiment, the DB1-listed athletes have, as a safeguard for their amateur status, agreed to license terms as a requirement of their registration.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention

Reference to “first,” “second,” “third,” and so forth members throughout the disclosure (and in particular, claims) are not used to show a serial or numerical limitation but instead are used to distinguish or identify the various members of the group.

1. A computer-enabled system for improving efficiency of sale and purchase of NIL licenses, said system comprising simultaneous license-group purchase.

2. The system of claim 1, further comprising single click to execute said purchase.

3. The system of claim 1, further comprising synchronized plurality of databases.

4. The system of claim 1, further comprising data from a first database compiled to a second database as team list component.

5. The system of claim 1, further comprising same price per plurality of licenses within said license-group purchase.

6. The system of claim 1, further comprising said group purchase of licenses comprising purchase of license from each of a plurality of athletes of same sports team.

7. The system of claim 6, further comprising said group purchase of licenses as comprised of licenses from athletes each of at least similar playing designation.

8. A method for electronically allowing group purchase of NIL licenses, said method comprising steps:
using online licensing platform, and
allowing said purchase as simultaneous.

9. The method of claim 8, further comprising step of plurality of registered users of said platform each agreeing to electronically displayed license agreement.

10. The method of claim 8, further comprising step of comprising said purchased licenses as at least a plurality purchased from athletes of same sports team.

11. The method of claim 10, further comprising said plurality of athletes of at least similar playing position.

12. A computerized system for improving efficiency of sale of NIL licenses, said system comprising computational hardware allowing for means for a user to agree to license terms electronically, and further allowing means for said user to simultaneously purchase at least one license from each of a plurality of student-athletes listed on online-viewable team roster of said system.

13. The system of claim 12, further comprising a user allowed to pay same price to each of said plurality.

14. The system of claim 12, further comprising downloadable badges.

15. The system of claim 12, further comprising restriction of edit permission regarding team list.

16. The system of claim 12, further comprising a plurality of synchronized searchable databases, each comprising data regarding online license platform-registered student-athletes.

17. The system of claim 12, further comprising use of county of location of high school.

18. The system of claim 12, further comprising use of list of states comprising those states having legal approval of NIL for high school student-athletes.

19. The system of claim 12, further comprising user-selected designation regarding at least one of varsity, junior varsity, offense, defense, lineman, quarterback, safety, receiver, point guard, shooting guard, center, forward.

20. The system of claim 12, further comprising license-group purchase as simultaneously enabled.
